(19) United States
(12) Patent Application Publication
(10) Pub. No.: US 2005/0227685 A1
(43) Pub. Date: Oct. 13, 2005

(54) Sip based call setup

(76) Inventors: Jose Costa Requena, Helsinki (FI); Immaculada Espigares Del Pozo, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/515,531

(22) PCT Filed: May 30, 2002
(86) PCT No.: PCT/IB02/01902

§ 371 Date: May 25, 2005

(51) Int. Cl. H04Q 7/20

(52) U.S. Cl. 455/423

(57) ABSTRACT

A method and system for status communication within a cellular telecommunications network, and especially a 3^{rd} Generation (3G) mobile network, such as the new UMTS (Universal Mobile Telecommunication System) are provided. In the method information is communicated to a user terminal about abnormal condition occurring during an ongoing call in a cellular telecommunications network in which an element (404, 602) controlling the connection is separate from a system part providing transport of user data (401, 401). In this method, existence of an abnormal condition in the status of the connection is detected in a system port of the network providing transport of user data and forwarded to the element controlling the connection. This element then determines the state of the connection to the user terminal based on the received message, and subsequently forwards information about the state of the connection to the user.

### FIELD OF THE INVENTION

The present invention relates to a method and a system for status communication within a cellular telecommunication network, and especially a 3^{rd} Generation (3G) mobile network, such as the new UMTS (Universal Mobile Telecommunications System).

### BACKGROUND OF THE INVENTION

Communication of status regarding the call and connection is often troublesome within the 3^{rd} Generation (3G) of Mobile Networks, and especially with the new UMTS (Universal Mobile Telecommunication System) using the SIP (Session Initiation Protocol) protocol. In many telecommunications network systems, such as the new UMTS system, there is no way to communicate between the terminal and network entities, such as the CSCF (Call State Control Function), about abnormal situations that could arise within the mobile network. Such information would be needed in order to terminate the connection during such abnormal situations. It would be advantageous to avoid keeping allocated network and radio resources once the user is not reachable any more, since this would decrease traffic in the network and thereby increase the available capacity.

A possible solution to this problem, suggested by the IETF (Internet engineering Task Force) group, is to use a Session Timer in the SIP. This is discussed in an Internet Draft titled “The SIP session timer” published on Oct. 6, 2001 by S Donovan and J Rosenberg. SIP does not define a keep-alive mechanism and therefore it is proposed to define a session timer to indicate whether a call is still active or not. To this end it is proposed to use the SIP INVITE method where the Session-Expires header indicates for how long the actual call is valid. The Session-Expires header sets up a timeout and the user assigned as the Refresher in the 2xx response generates a refresh (using a re-INVITE) before the session expires with a new Session-Expires header, indicating that the call is still ongoing. However, a drawback of this solution is that a suitable expiration time is not easy to determine. For example, if the timeout is set to a lower value, the user needs to refresh the call quite often, leading to an increase in the traffic of messages. Likewise, if the timeout is set to a longer period the situation could arise that the user is already down and the network did not realize this, whereby all the radio resources will be occupied until the timeout expires.

Another solution proposed by the IETF is disclosed in “SIP Call Control” of Jan. 16, 2002 by R Sparks. Here it is proposed to provide Call Transfer capabilities in SIP. To this end, REFER is used to achieve call transfer. A REFER can be issued by the transferor to cause the transferee to issue an INVITE to the transfer-target. However, a successful REFER transaction does not terminate the session between the transferor and the transferee. The REFER process provides a good flexibility for recovery from failure but this is often not necessary. Accordingly, this method is unduly complex and costly.

### SUMMARY OF THE INVENTION

It is therefore an object of the present invention to provide a method and a system for exchanging information about an abnormal condition occurring in a cellular telecommunication network during an ongoing call and/or to decrease traffic in the network.

This object is achieved with a method and a telecommunication system according to the appended claims.

According to a first aspect of the invention there is provided a method for communicating status information to a user terminal about an abnormal condition occurring during an ongoing call in a cellular telecommunication network in which an element controlling the connection is separate from a system part providing transport of user data, the method comprising the steps of:
detecting the existence of an abnormal condition in the status of the connection in a system part of the network providing transport of user data;
forwarding the information about the abnormal condition within a first message to the element controlling the connection;
deciding in the controlling element the state of the connection to the user terminal based on the received first message; and
forwarding the information about the state of the connection within a second message to the user.

According to another aspect of the invention, there is provided a telecommunication system comprising:
an element (404, 602) controlling a connection to a user terminal (101) and a system part (401, 402) providing transport of user data, which system part is separate from said controlling element,
wherein a system element which detects the state of the connection to the user terminal is arranged to send a first message about an abnormal condition to the controlling element indicating the state of the connection, and the controlling element is arranged to decide the state of the connection to the user terminal based on the received first message, and to forward the information about the state of the connection within a second message to the user.

An important advantage of the invention is that it decreases the traffic in the network.

Thus, the invention solves the problem of abnormal situations within the 3^{rd} Generation of Mobile Networks. That information needs to be available for terminating the connection during such strange situations. It is necessary to avoid keeping allocated network and radio resources once the user is not reachable any more. This invention also provides a solution that utilizes the SIP Signaling protocol for informing the network entity, where the user is actually attached about the status of the connection.

Preferably, the communication uses defined SIP methods like INFO, SUBSCRIBE and NOTIFY for informing the user about any abnormal conditions that the network found out about the ongoing call. The INFO method is preferably used only for informing the user about any abnormal condition that the network found out about the ongoing call.

This solution will improve the Session Timer based solution, known from the prior art, in the sense of decreasing the traffic in the network.

The invention is advantageous in the way that the SIP protocol provides enough flexibility for implementing this service using the already defined methods, just making an efficient use of them. Accordingly, with this approach the reliability of the SIP is increased.

### BRIEF DESCRIPTION OF THE DRAWINGS

For exemplifying purposes, the invention will be described in closer detail in the following with reference to embodiments thereof illustrated in the attached drawings, wherein:

FIG. 1 is a schematic overview of a telecommunication network in accordance with the present invention; and

FIG. 2 is a more detailed overview of the telecommunication network of FIG. 1.

### DESCRIPTION OF THE PREFERRED EMBODIMENTS

The present invention can be applied to various telecommunication systems. Such systems include third generation mobile communication systems, such as UMTS (Universal Mobile Telecommunications System). The invention will be described in the following using an UMTS system, as an exemple system without restricting the invention thereto. All words and expressions should therefore be interpreted broadly since they are only intended to illustrate, not to restrict, the invention. The essential point of the invention is the function, not the network element where the function is located.

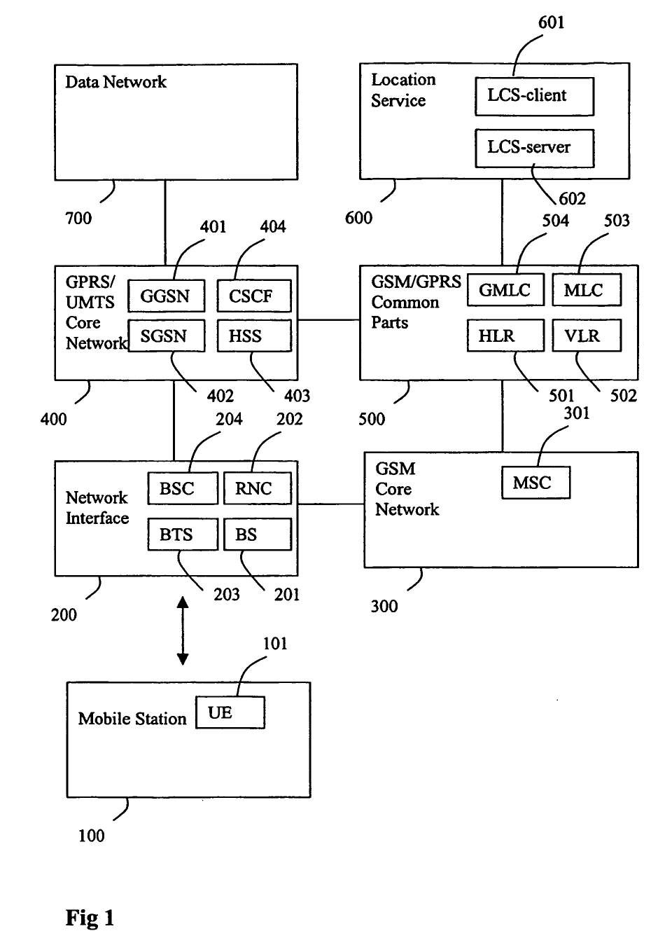

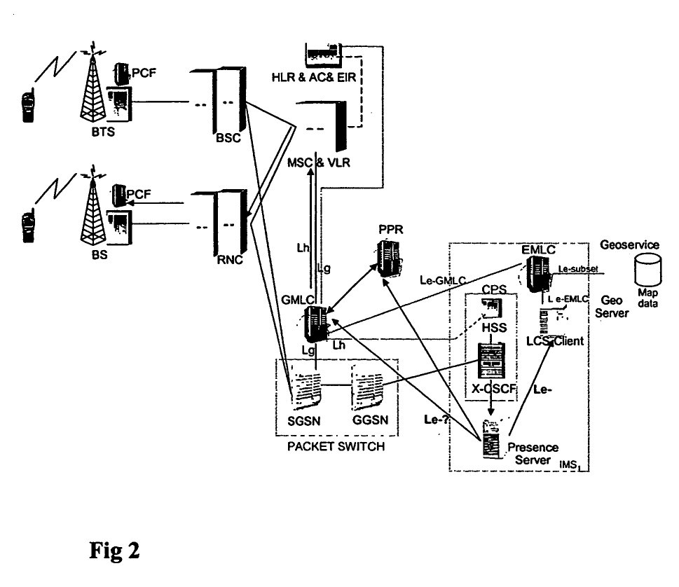

FIG. 1 presents a schematic diagram of a cellular telecommunication network in which the invention could be used, and FIG. 2 presents a more detailed view of the same network.

A mobile station (100) such as a user terminal or user equipment (UE) (101) communicates with one or several base stations. The user terminal may e.g. be a laptop computer or a PDA (Personal Digital Assistant) or a mobile phone.

The mobile station communicates with a network interface (200). In the GSM radio access network, base stations (BS) (201) are connected to the radio network controllers (RNC) (202), whereas in the GPRS network base transceiver stations (BTS) (203) are connected to base station controllers (BSC) (204). The controllers are responsible, for example, for allocation of radio resources and for handling handovers, when a mobile station changes the base station it communicates with. Thus, in cellular telecommunication networks, a base transceiver station (BTS) (203) serves the mobile stations (MS) (100) or similar wireless user equipment (UE) (101) via an air or radio interface. The base station provides a coverage area that can be defined as a certain geographically limited area referred to as a cell. The size and shape of the cells may vary from cell to cell.

In an example of the network architecture of an UMTS system, main parts of the system are a radio access network providing access to user terminals UE (User Equipment) and at least one core network.

In the disclosed embodiment, there are separate core networks for the GSM and the GPRS. A GSM core network (300) comprises in the fixed part of the network Mobile Service Switching centers (MSC) (301), to which the RNC is connected. The GSM core network (300) is usually connected to a Public Switched Telephone Network (PSTN). The GPRS core network (400) comprises GPRS supporting nodes (GSN). Of these nodes, the one which interfaces a packet data network (700), for example the Internet, is called Gateway GPRS supporting node (GGSN) (401). Data packets may run through many GSNs, which act as routers. A mobile station or a packet data device connected to the mobile station, which is the end point of the data connection, is reachable through one base station controller and the GSN connected to this base station controller is called Serving GPRS support node (SGSN) (402). The function of the support node is to transmit packets between the base station system and the GGSN and keep a record of the location of the subscriber terminal in its area.

Accordingly, the core UMTS network comprises a SGSN and a GGSN. Further, it comprises an HSS (Home Subscriber Server) (403) and a CSCF (Call State Control Function) (404). The support nodes SGSN and GGSN are interconnected by a backbone network, such as an IP/ATM (Internet Protocol/Asynchronous Transfer Mode) network. It should be noted that the functionalities of the SGSN and the GGSN can also be physically combined into the same network node, in which case the backbone network is unnecessary. Logically, however, the nodes are separate nodes. It should be noted that core networks of other types might comprise other network elements.

The CSCF controls call establishment and is responsible for routing calls, and comprises, for example, a function corresponding to a switching function in the intelligent network. E.g. the CSCF provides IP telephony services with end-to-end control. Signalling associated with the IP telephony, such SIP (Session Initiation Protocol), terminates at the user equipment and the CSCF. The Session Initiation Protocol (SIP) developed by IETF (Internet Engineering Task Force) is an application-layer control (signalling) protocol for creating, modifying and terminating sessions with one or more participants. These sessions include e.g. Internet multimedia conferences, Internet telephone calls and multimedia distribution. In other words, the CSCF is the network node in which IP telephony user equipment UE is registered and via which the signalling is transferred.

Within this application the term “controlling element” refers generally to an element or entity controlling a call, the CSCF being merely an example of such element.

The HSS (Home Subscriber Server) is the master database for a given user. It is responsible for keeping a master list of features and services (either directly or via servers) associated with the user, and for tracking of location and means of access for its users, i.e., provides the subscriber profile.

There are also network elements, which are common for the GSM and GPRS networks. In FIG. 1 the common part of the GSM and GPRS networks is presented as a separate entity (500). The common part of the GSM and GPRS comprises, for example, Home Location Register (HLR) (501) and Visitor Location Register (VLR) (502), which take part in subscriber and mobility management. Furthermore, there is an entity called Mobile Location Center (MLC) (503), which is responsible for determining the location of a mobile station. An entity, which is external to the GSM network, may query the location of a certain mobile station by sending a location request to a Gateway Mobile Location Center (GMLC) (504).

An entity (600) requesting the location of a certain mobile station is usually called a Location Service (LCS) Client (601). This entity sends a LCS request to the GMLC, the request comprising an identifier, for example IMSI (International Mobile Subscriber Identifier) or MSISDN, specifying the mobile station, whose location is queried. The GMLC authenticates the LCS Client to make sure that it is entitled to receive location information. After successful authentication the GMLC asks with the Routing Data message the HLR, which is related to the mobile station, the current or latest MSC, through which the mobile has been reachable; this MSC is called the Visiting MSC (VMSC). After receiving information about the VMSC from the HLR, the GMLC send a Subscriber Request to this VMSC. The VMSC typically pages the mobile station in question to receive information about the cell, in which the mobile station currently is. Thereafter the mobile station is notified of the location query with a LCS notification. There are various possible ways to determine the location of a mobile station: the cellular network may calculate the location of a mobile station using only the information it has, the mobile station may provide some information for the location process, or the mobile station may perform the location itself, and inform the network about its current location.

Preferably, the LCS-client (601) is connected to a LCS-server (602), or presence server, providing location services for different applications or clients. In general terms, the LCS-server can be defined as an entity capable of providing information concerning the geographical location of a mobile station, and more particularly, the geographical location defined on the basis of the position of the mobile station relative to the base station(s) of the mobile telecommunication network. A more detailed description of a possible LCS-server and LCS-client can be found, for example, from 3^{rd} Generation Partnership Project, Technical Specification Group Services and System Aspects “Functional stage 2 description of LCS” (3GPP TS23.271). This document is hereby incorporated herein by reference.

Location of a subscriber terminal, i.e. determination of the geographical location of a subscriber terminal, is an important function in cellular radio networks. For example, it is often required that one should be able to locate all subscriber terminals that make emergency calls. Location can also be used for commercial purposes, e.g. for defining various tariff areas or for implementing a navigation service which guides the user. To this end, a location service (LCS) is normally employed.

Various methods are used for implementing the location service. At the least accurate level the location of a subscriber terminal can be determined on the basis of the identity of the cell that serves the subscriber terminal. This does not provide very accurate information because the diameter of a cell can be dozens of kilometers. A more accurate result is obtained by using timing information on the radio connection as additional information, e.g. the timing advance TA. However, several other location methods are available as well.

Here, the UMTS network is used as an example of telecommunication networks in which the present invention could be used. However, many other types of telecommunication networks could be used as well.

The structure of the packet-switched radio system and its connections to a public switched telephone network and packet transmission network described above with reference to FIG. 1 and FIG. 2 includes only the blocks necessary for describing the present invention, but it is clear to a person skilled in the art that a cellular telecommunication network also comprises other functions and structures that need not be described in greater detail here.

The structure of the different components and units discussed above is not described more closely because it is clear to a person skilled in the art how these devices are implemented.

In a preferred embodiment, the invention is employed in an UMTS telecommunication network. Actually, in UMTS systems there are at present no way to communicate between the user terminal and the CSCF about abnormal events. There is not even any possible mechanism to keep updated the call status. The method of the invention provides the means for keeping track of the user situation in case of any strange behaviors.

In this embodiment of the invention, an interface is arranged between the Gateway Mobile Location Center (GMLC) and the Call State Control Function (CSCF) at UMTS networks. The aim of this interface is to facilitate the exchange of location information between Location Service elements such as GGSN (Gateway GPRS Support Node) and 3G network elements. This interface can e.g. be run over RADIUS that is available right now in GGSN. However, preferably the exchange procedure and the exchange format of the messages are set to facilitate the communication between both elements. Accordingly, this interface serves to forward a first message from a system part providing transport of user data, such as the GGSN, to an element controlling the connection, such as the CSFC. The first message comprises information about the abnormal condition detected within the system part providing transport of user data.

The arrangement of this interface solves the actual problem of finding the right way for triggering the location information from the GGSN and translate it to the right format to be used at the CSCF. Thus, the 3G terminal will interact directly with the CSCF requesting his location information and based on this functionality ARI (Access Request Information), that towards the GMLC would behave as a LCS client, the CSCF can request that information directly from the GGSN or GMLC, depending on where the information is available at the moment. Accordingly, the problem with the additional load due to the use of a timer to trigger that information periodically either from the GGSN or from the GMLC towards the CSCF, as is experienced in the prior art, could hereby be alleviated.

Preferably, the invention is embodied in an UMTS system based on the Session Initiation Protocol (SIP) protocol. In that case, a suitable solution for managing information transfer about abnormal occurrences and abnormal call termination could be to utilize the already defined SIP methods such as INFO, SUBSCRIBE and NOTIFY. This will provide means for informing the network entities about the abnormal situation of the user and according to the user response the network could decide whether to terminate the call or not. SIP is a protocol for controlling a call between the different CSCFs and the UE connected thereto. In the following, some aspects of SIP are described in short.

A number of functions are defined in the SIP, among which only the ones relevant to the present invention will be discussed briefly:
The SUBSCRIBE method allows a SIP Client (terminal or application) to subscribe to a certain event that will trigger a notification using the NOTIFY method.
The INFO method is used for informing about any happening during an ongoing session.
The NOTIFY method provides a NOTIFY message to be sent to the terminal/application when an event to which the terminal subscribed occurred.

The INFO method is used only for informing the user about any abnormal condition that the network found out about the ongoing call. The SUBSCRIBE method is used for indicating to the network that the user desires to be aware of any change in the session. If something erroneous happens the network will send a NOTIFY message to the user indicating the type of problem that has occurred in the Event header and in case it has to establish a new session with another entity the same NOTIFY message will bring the new contact address in the Contact header of the same NOTIFY message.

Thus, the SIP will utilize the INFO method for indicating to the Mobile Terminal that something is going wrong with the actual connection. The INFO method will include the reason why it has suspicions about an abnormal behavior. Furthermore, the user upon receiving that message will send back the 200 OK saying that user got the message. Due to this procedure, the network is sure that the user is still alive. If, within a short period of time, the user does not send back any message then the network will re-send the INFO indicating that the problem persists. If the network at this point does not receive any answer it means that the user is down and then it will terminate the connection.

Accordingly, SIP functionalities could, as discussed above, be used both for forwarding information about the state of the connection within a second message to the user, e.g. in an INFO or NOTIFY message, and for determination of the severity of the detected abnormal condition, e.g. based on the response on a NOTIFY message.

For indication of the occurrence of the abnormal condition, it is possible to use a signal coming from the radio access indicating that the radio strength of that user is going down and then the network can start this above-discussed set of messages for being sure that the user keeps the connection.

Abnormalities could be detected by means of the presence server (LCS-server). The presence server preferably administers presence documents, comprising presence data for different entities. This information can be collected from multiple sources e.g. from the network, from users, or from the terminals. The presence data can represent a part or a whole of user's presence, i.e. it can be a one presence tuple, one parameter inside a presence tuple or a whole presence document. A tuple is a data structure that is used in Presence service for containing any presence related information such as terminal status, location, addresses, etc.

In order to support the Presence server functionality, the set of functionality which is preferably present in the network for completing the presence service will now be discussed.

Preferably, there are one or several attribute(s) describing the status of the device. These attributes are device dependent but the network will have an active role when providing the information. Those attributes could be:
Terminal registered to the network (ON/OFF)
Communication address of the device Further, there is preferably an attribute describing the call state of the device, i.e. if the call is active or inactive. The network has a complete knowledge about the call state on the terminal at any moment.

Still further, a network provided (geographical) location attribute is preferably supported. The network preferably updates the location information in the presence document. The user could set the trigger in the network that will indicate when to update the geographical location.

A network provided attribute of the time zone based on user's location is also preferably supported.

The network could also provide a policy mechanism that will apply to the watchers, i.e. entities observing the presence status, when accessing the presence information. The network should preferably guarantee the mechanism to link the block list with the presence data to perform the authorization procedure.

A mechanism could also be provided to synchronize changes between different devices (sessions). This implies that either the network or the terminal should keep an active role. The network can keep track of active sessions that can change the presence data and should be notified to other devices. The changes that could be observed are:
Changes in own Presence
Changes in contact lists (authorization)
Changes in block list

In the following the mechanism to provide input information to the presence document from the network will be discussed.

The following attributes can be uploaded in the presence document directly from the terminal registration. The information is provided implicitly in the “Contact” (Device status and communication address) and “Date” (Local Time zone) headers within the REGISTER message. Afterwards, the information is preferably refreshed in the presence document per message basis. (i.e. when the terminals initiates a session this information should be uploaded in the Call state attribute information within the presence data). The attributes that are preferably update in this way are:
Device status
Call state attributes
Local Time zone attribute

The following information is preferably uploaded in the presence document from the LCS Client. It requires that a network entity on behalf of the user triggers the location information request and the GMLC provides the information back into the presence server.

The presence server, via the LCS, subscribes to the GMLC on behalf of the user in order to get the location information. Therefore, the LCS keeps the subscription state within the presence server for fetching the location information from the GMLC periodically.

For example, the updating process could operate as follows: The user registers in the network and the transaction implicitly updates the presence document (Device status, Call state and Local Time) and using the LCS client, it also triggers the subscription to the GMLC for getting the location information periodically. Alternatively, the following approach could be used, when though it adds extra functionality to the GMLC: The GMLC subscribes to the presence server like a watcher and when the user registers the GMLC receives a notification, which indicates that the location information has to be updated in the presence document.

In order to fetch the location information from the GMLC to be included in the presence document, the system includes the above-discussed interface to facilitate that process either directly from the LCS-client or from GMLC. The aim of this interface is preferably to include additional functionality to the LCS system. The interface is preferably SIP based and the GMLC could be an addressable Internet entity where the S-SCSF can forward the messages received from the Terminal. Therefore, the location request coming from the terminal could be handled at S-CSCF that based on the user profile either will forward it to the Application server or forward it directly to the GMLC that will calculate the location information and send it back in the SIP response.

The interface could be used for getting the location information and be aware of certain abnormal situations such as: emergency, out of coverage either in CS or PS (in one or the other case the terminal is located either under CS or PS and the information retrieved). According to the invention the CSCF can retrieve that information from the GMLC via the proposed interface. Preferably, the GMLC receives the query from the LCS, and, thus, the proposed interface would be between the CSCF and the LCS. Thus, the LCS will receive the query from the CSCF and forward the query to the GMLC, which will keep an active state for sending back the location information to the CSCF. Thus the GMLC only responds to the LCS and no extra functionality is added.

This approach facilitates the use of LCS with this new interface for CSCF and for presence server that is also needed. Thus the same interface can be used for both situations between the CSCF-LCS and the Presence Server-LCS.

1. A method for communicating status information to a user terminal about an abnormal condition occurring during an ongoing call in a cellular telecommunication network in which an element (404, 602) controlling the connection is separate from a system part providing transport of user data (401, 402), comprising the steps of:
detecting the existence of an abnormal condition in the status of the connection in a system part of the network providing transport of user data;
forwarding the information about the abnormal condition within a first message to the element controlling the connection;
deciding in the controlling element the state of the connection to the user terminal based on the received first message; and
forwarding the information about the state of the connection within a second message to the user.

2. The method of claim 1, wherein the telecommunication system uses the Session Initiation Protocol (SIP), and wherein the step of forwarding the second message utilizes a defined functionality in SIP.

3. The method of claim 2, wherein at least one of the defined flnctionalities INFO, SUBSCRIBE and NOTIFY are used for forwarding the information.

4. The method of claim 3, comprising the further steps of determining whether the abnormal condition is sever, and of terminating the call in case such a severe abnormal condition is determined.

5. The method of claim 4, wherein the step of determining whether the abnormal condition is severe comprises requiring a response from the user terminal, and, based on said response, determining the severity of the abnormal condition.

6. The method of claim 5, wherein the system part of the network providing transport of user data forwards the information about the abnormal condition to the element controlling the connection in response of a query from said controlling element.

7. A telecommunication system comprising:
an element (404, 602) controlling a connection to a terminal (101) and a system part (401, 402) providing transport of user data, which system part is separate from said controlling element,
wherein a system element which detects the state of the connection to the user terminal is arranged to send a first message about an abnormal condition to the controlling element indicating the state of the connection, and the controlling element is arranged to decide the state of the connection to the user terminal based on the received first message, and to forward the information about the state of the connection with a second message to the user.

8. The system of claim 7, wherein the controlling element comprises a Call State Control Function.

9. The system of claim 8, wherein the system is a Universal Mobile Telephony System (UMTS).

10. The system of claim 9, wherein the system is a Universal Mobile Telephony System (UMTS).

11. The system of claim 10, wherein the system part of the network providing transport of user data is arranged to forward the information about the abnormal condition to the element controlling the connection in response of a query from said controlling element.

12. The method of claim 1, comprising the further steps of determining whether the abnormal condition is sever, and of terminating the call in case such a severe abnormal condition is determined.

13. The method of claim 12, wherein the step of determining whether the abnormal condition is severe comprises requiring a response from the user terminal, and, based on said response, determining the severity of the abnormal condition.

14. The method of claim 13, wherein the system part of the network providing transport of user data forwards the information about the abnormal condition to the element controlling the connection in response of a query from said controlling element.

15. The system of claim 7, wherein the system is a Universal Mobile Telephony System (UMTS).

16. The system of claim 7, wherein the system is a Universal Mobile Telephony System (UMTS).

17. The system of claim 7, wherein the system part of the network providing transport of user data is arranged to forward the information about the abnormal condition to the element controlling the connection in response of a query from said controlling element.
